(19) United States
(12) Patent Application Publication
(10) Pub. No.: US 2023/0409007 A1
(43) Pub. Date: Dec. 21, 2023

(54) INFORMATION PROCESSING METHOD AND INFORMATION PROCESSING DEVICE

(71) Applicant: Panasonic Intellectual Property Corporation of America, Torrance, CA (US)

(72) Inventors: Kenta MURAKAMI, Osaka (JP); Satoshi SUEMASU, Osaka (JP); Yuki TAKAOKA, Osaka (JP)

(73) Assignee: Panasonic Intellectual Property Corporation of America, Torrance, CA (US)

(21) Appl. No.: 18/228,851

(22) Filed: Aug. 1, 2023

Related U.S. Application Data
(63) Continuation of application No. PCT/JP2022/003754, filed on Feb. 1, 2022.

(30) Foreign Application Priority Data
Feb. 5, 2021 (JP) 2021-017564

(51) Int. Cl. G05B 19/4155

(52) U.S. Cl. CPC G05B 19/4155; G05B 2219/50333

(57) ABSTRACT

Provided is an information processing device configured to: start an application including multiple blocks each including a parameter for controlling an apparatus including at least one of an actuator and a heater, and a sequence including one or more processes involving at least a motion of a person, the sequence cooperating with an N+1th block of the application after completion of an Mth process; generate a state maintaining block having a parameter for maintaining a state of a processing object of the apparatus at completion of an Nth block; and execute the generated state maintaining block when completion of the Nth block is detected.

### FIELD OF INVENTION

The present disclosure relates to a technique for executing an application including multiple blocks.

### BACKGROUND ART

Patent Literature 1 discloses a washing machine that causing a combination inconvenient for set contents of wash in a process subsequent to the wash to be unable to be selected in accordance with selected set contents of the wash, thereby allowing a user to easily and quickly set operating conditions of washing to be performed.

Unfortunately, only a process of the washing machine is managed in Patent Literature 1, so that cooperation between a sequence including a process involving a motion of a person and a block executed by an apparatus is not considered at all. Thus, when the process involving the motion of the person is delayed due to skill of the person, deterioration in quality of a processing object of the apparatus cannot be suppressed, and thus further improvement is necessary.
Patent Literature 1: JP 2003-284889 A

### SUMMARY OF THE INVENTION

It is an object of the present disclosure to provide a technique capable of suppressing deterioration in quality of a processing object of an apparatus even when a process involving a motion of a person is delayed due to skill of the person, or the like.

An information processing method according to one aspect of the present disclosure is an information processing method that is executed by a computer, the method including: starting an application including multiple blocks each having a parameter for controlling an apparatus including at least one of an actuator and a heater, and a sequence including one or more processes involving at least a motion of a person, the sequence cooperating with an N+1th block (N is an integer of 1 or more) of the application after completion of an Mth process (M is an integer of 1 or more); generating a state maintaining block having a parameter for maintaining a state of a processing object of the apparatus at completion of an Nth block; and executing the generated state maintaining block when completion of the Nth block is detected.

The present disclosure enables suppressing deterioration in quality of a processing object of an apparatus even when a process involving a motion of a person is delayed due to skill of the person, or the like.

### BRIEF DESCRIPTION OF THE DRAWINGS

FIG. 1 is a diagram illustrating an example of a general configuration of an information processing system according to a first embodiment of the present disclosure.

FIG. 2 is a block diagram illustrating an example of a configuration of a server according to the first embodiment of the present disclosure.

FIG. 3 is a block diagram illustrating an example of a configuration of an apparatus.

FIG. 4 is a block diagram illustrating an example of a configuration of a terminal.

FIG. 5 is a flowchart illustrating an example of processing of the server according to the first embodiment of the present disclosure.

FIG. 6 is a sequence diagram illustrating execution of a state maintaining block in the first embodiment of the present disclosure.

FIG. 7 is a diagram illustrating an example of a data configuration of a parameter table.

FIG. 8 is a block diagram illustrating an example of a configuration of a server according to a second embodiment of the present disclosure.

FIG. 9 is a flowchart illustrating an example of processing of the server according to the second embodiment of the present disclosure.

FIG. 10 is a block diagram illustrating an example of a configuration of a server according to a third embodiment of the present disclosure.

FIG. 11 is a flowchart illustrating an example of processing of the server according to the third embodiment of the present disclosure.

FIG. 12 is a sequence diagram illustrating execution of a state maintaining block in the third embodiment of the present disclosure.

FIG. 13 is a block diagram illustrating an example of a configuration of a server according to a fourth embodiment of the present disclosure.

FIG. 14 is a flowchart illustrating an example of processing of the server according to the fourth embodiment of the present disclosure.

FIG. 15 is a block diagram illustrating an example of a configuration of a server according to a fifth embodiment of the present disclosure.

FIG. 16 is a flowchart illustrating an example of processing of the server according to the fifth embodiment of the present disclosure.

FIG. 17 is a sequence diagram illustrating execution of a state maintaining block in the fifth embodiment of the present disclosure.

FIG. 18 is a block diagram illustrating an example of processing of a server according to a sixth embodiment.

FIG. 19 is a flowchart illustrating an example of processing of the server according to the sixth embodiment of the present disclosure.

### DETAILED DESCRIPTION

### Knowledge Underlying Present Disclosure

Research on a technique for cooperating an application including multiple blocks each having a parameter for controlling an apparatus with a sequence including one or more processes involving a motion of a person has been advanced. Examples of the cooperation include a case where a certain block constituting an application uses a processing object obtained by a certain process constituting a sequence.

The apparatus operates almost as intended, while the motion of the person depends on skill of the person. Thus, a process of obtaining the processing object using the motion of the person may be delayed with respect to the block using the processing object. Conceivable methods for this case include a method for stopping operation of the apparatus by turning off power of an actuator of the apparatus or the like until the process of obtaining the processing object is completed to cause the block using the processing object to wait to start execution.

Unfortunately, this method may cause a state of the processing object processed by the apparatus in a block before the block using the processing object to change in accordance with a standby time. For example, when an ingredient cut by a person is put into a cooking apparatus and the put ingredient and an ingredient cooked by the cooking apparatus by then are further cooked using the cooking apparatus, delay in a process of cutting the ingredient cause the ingredient in the cooking apparatus to cool down to lead to deterioration in taste thereof. This results in deterioration in quality of the finally obtained processing object.

The examples of the cooperation also include a case where a certain process constituting the sequence and a certain block constituting the application are completed at the same timing. Examples of the case include a case where spin-drying of a washing machine is completed at timing when tidying up of a meal is completed. Conceivable methods for this case include a method for delaying start timing of the spin-drying so that the spin-drying is completed at the same timing when the tidying is completed.

Unfortunately, the spin-drying is performed after water used for rinsing is drained, so that the spin-drying started after a while from the drainage may cause an unpleasant odor and wrinkles in laundry. This leads to deterioration in quality of the processing object of the apparatus.

Additionally, it is difficult to predict a delay time of a process involving a motion of a person in an application development stage, so that it is not easy for an application developer to develop an application in which blocks are disposed in advance without causing such a delay.

The present disclosure has been made to solve problems as described above, and it is an object of the present disclosure to provide a technique capable of suppressing deterioration in quality of a processing object of an apparatus even when a process involving a motion of a person is delayed due to skill of the person, or the like.

An information processing method according to one aspect of the present disclosure is an information processing method that is executed by a computer, the method including: starting an application including multiple blocks each having a parameter for controlling an apparatus including at least one of an actuator and a heater, and a sequence including one or more processes involving at least a motion of a person, the sequence cooperating with an N+1th block (N is an integer of 1 or more) of the application after completion of an Mth process (M is an integer of 1 or more); generating a state maintaining block having a parameter for maintaining a state of a processing object of the apparatus at completion of an Nth block; and executing the generated state maintaining block when completion of the Nth block is detected.

The present configuration causes the state maintaining block for maintaining a state of the processing object of the apparatus at completion of execution of the Nth block to be generated when the N+1th block (N is an integer of 1 or more) of the application and the sequence cooperate with each other after completion of the Mth process. Then, when completion of the Nth block is detected, the generated state maintaining block is executed. Thus, even when processes up to the Mth process are delayed due to the skill of the person, or the like, the state of the processing object of the apparatus at the completion of the Nth block is maintained, and thus enabling deterioration in quality of the processing object of the apparatus to be suppressed.

The above information processing method may further include ending the state maintaining block and executing the N+1th block when completion of the Mth process is detected during execution of the state maintaining block.

The present configuration enables cooperating the sequence with the N+1th block after waiting for reliable completion of the Mth process because the state maintaining block is ended and the N+1th block is executed when the completion of the Mth process is detected during the execution of the state maintaining block.

In the above information processing method, the state maintaining block may include multiple parameters with different priorities, and the multiple parameters may be different in accordance with a type of the Nth block.

The present configuration enables generating the state maintaining block including the multiple parameters appropriate for the type of the Nth block. Additionally, the multiple parameters have the different priorities, so that the parameters to be executed by the apparatus can be selected in accordance with the corresponding priorities.

The above information processing method may further include acquiring power consumption of the apparatus, in which the executing the state maintaining block includes determining the parameters to be executed by the apparatus based on the acquired power consumption and the corresponding priorities.

The present configuration enables determining the parameters to be executed by the apparatus in consideration of the power consumption of the apparatus and the corresponding priorities. For example, the present configuration enables control of the apparatus such that a parameter with the highest priority is executed by the apparatus when the state maintaining block is started, and a parameter with the next highest priority is executed by the apparatus when the power consumption of the apparatus after elapse of a predetermined time is equal to or less than a threshold. As a result, the processing object of the apparatus can be maintained in a more appropriate state as much as possible while the power consumption is suppressed.

In the above information processing method, the sequence may further include a process of operating an apparatus.

The present configuration enables suppressing deterioration in quality of the processing object of the apparatus even when a process involving a motion of a person is delayed in the sequence further including a process in which the apparatus operates in addition to the process involving the motion of the person.

In the above information processing method, the generating the state maintaining block may include determining generation of the state maintaining block when delays of processes up to an M−1th process are detected.

The present configuration determines the generation of the state maintaining block when the delays of the processes up to the M−1th process are detected. Thus, when a delay of the Mth process is obvious due to the delay of the M−1th process before the Mth process is started, the generation of the state maintaining block can be determined.

In the above information processing method, the generating the state maintaining block may include acquiring, from a sensor of the apparatus, sensing data indicating a state of the processing object of the apparatus at completion of the Nth block, and determining a value of the parameter of the state maintaining block based on the sensing data.

The present configuration enables the parameter of the state maintaining block to be determined to have a value appropriate for maintaining the state of the processing object because the value of the state maintaining block is determined based on the sensing data when the Nth block is completed.

An information processing device according to another aspect of the present disclosure includes: a starter configured to start an application including multiple blocks each including a parameter for controlling an apparatus including at least one of an actuator and a heater, and a sequence including one or more processes involving at least a motion of a person, the sequence cooperating with an N+1th block (N is an integer of 1 or more) of the application after completion of an Mth process (M is an integer of 1 or more); a generator configured to generate a state maintaining block having a parameter for maintaining a state of a processing object of the apparatus at completion of an Nth block; and an execution unit configured to execute the state maintaining block when completion of the Nth block is detected.

The present configuration enables providing the information processing device that can obtain an effect similar to that of the information processing method described above.

An information processing method according to yet another aspect of the present disclosure is an information processing method that is executed by a computer, and the method may include: starting an application including multiple blocks each having a parameter for controlling an apparatus including at least one of an actuator and a heater, and a sequence including one or more processes involving at least a motion of a person, the sequence cooperating with an N+1th block (N is an integer of 1 or more) of the application after completion of an Mth process (M is an integer of 1 or more); and extending an Nth block until the Mth process is completed.

The present configuration extends the Nth block until the Mth process is completed when the N+1th block (N is an integer of 1 or more) of the application and the sequence cooperate with each other after completion of the Mth process. Thus, even when the Mth process is delayed due to skill of a person, deterioration in quality of the processing object of the apparatus can be suppressed. Additionally, the Nth block is extended, so that time and effort for separately generating a block is saved to reduce processing load.

An information processing device according to another aspect of the present disclosure includes: a starter configured to start an application including multiple blocks each including a parameter for controlling an apparatus including at least one of an actuator and a heater, and a sequence including one or more processes involving at least a motion of a person, the sequence cooperating with an N+1th block (N is an integer of 1 or more) of the application after completion of an Mth process (M is an integer of 1 or more); and an extension unit configured to extend an Nth block until the Mth process is completed.

The present configuration enables providing the information processing device that can obtain an effect similar to that of the information processing method described above.

An information processing method according to yet another aspect of the present disclosure is an information processing method that is executed by a computer, the method including: starting an application including multiple blocks each having a parameter for controlling an apparatus including at least one of an actuator and a heater, and a sequence including one or more processes involving at least a motion of a person; repeatedly calculating a first scheduled completion time of an N+1th block (N is an integer of 1 or more) of the application and a second scheduled completion time of an Mth process (M is an integer of 1 or more) of the sequence; generating a state maintaining block including a parameter for maintaining a state of a processing object of the apparatus at completion of an Nth block; determining whether the first scheduled completion time coincides with the second scheduled completion time; and executing the state maintaining block until determination is made that the first scheduled completion time coincides with the second scheduled completion time.

The present configuration executes the state maintaining block until determination is made that the first scheduled completion time of the N+1th block (N is an integer of 1 or more) of the application coincides with the second scheduled completion time of the Mth process (M is an integer of 1 or more) of the sequence. Thus, even when processes up to the Mth process are delayed, the state of the processing object at completion of the Nth block is maintained, and thus enabling completion time of the N+1th block to coincide with completion time of the Mth process while suppressing deterioration in quality of the processing object.

In the above information processing method, the first scheduled completion time may be calculated by adding a total time to a current time, the total time being acquired by totaling a remaining time with respect to a reference time predetermined for a block currently being executed and a reference time predetermined for each of blocks from a block to be executed subsequently, to the N+1th block, and the second scheduled completion time may be calculated by adding a total time to a current time, the total time being acquired by totaling a remaining time with respect to a reference time predetermined for a process currently being executed and a reference time predetermined for each of processes from a process to be executed subsequently, to the Mth process.

The present configuration enables the first scheduled completion time and the second scheduled completion time to be accurately calculated.

An information processing device according to yet another aspect of the present disclosure includes: a starter configured to start an application including multiple blocks each having a parameter for controlling an apparatus including at least one of an actuator and a heater, and a sequence including one or more processes involving at least a motion of a person; a calculator configured to repeatedly calculate a first scheduled completion time of an N+1th block (N is an integer of 1 or more) of the application and a second scheduled completion time of an Mth process (M is an integer of 1 or more) of the sequence; a generator configured to generate a state maintaining block including a parameter for maintaining a state of a processing object of the apparatus at completion of an Nth block; a determination unit configured to determine whether the first scheduled completion time coincides with the second scheduled completion time; and an execution unit configured to execute the state maintaining block until determination is made by the determination unit that the first scheduled completion time coincides with the second scheduled completion time.

The present configuration enables providing the information processing device that can obtain an effect similar to that of the information processing method described above.

An information processing method according to yet another aspect of the present disclosure is an information processing method that is executed by a computer, the method including: starting an application including multiple blocks each having a parameter for controlling an apparatus including at least one of an actuator and a heater, and a sequence including one or more processes involving at least a motion of a person; repeatedly calculating a first scheduled completion time of an N+1th block (N is an integer of 1 or more) of the application and a second scheduled completion time of an Mth process (M is an integer of 1 or more) of the sequence; determining whether the first scheduled completion time coincides with the second scheduled completion time; and extending an Nth block until determination is made that the first scheduled completion time coincides with the second scheduled completion time.

The present configuration extends the Nth block until the first scheduled completion time coincides with the second scheduled completion time when the first scheduled completion time of the N+1th block (N is an integer of 1 or more) of the application does not coincides with the second scheduled completion time of the Mth process (M is an integer of 1 or more) of the sequence. Thus, even when processes up to the Mth process are delayed, the state of the processing object at the completion of the Nth block is maintained, and thus enabling completion timing of the N+1th block to coincide with completion timing of the Mth process while suppressing deterioration in quality of the processing object.

An information processing device according to yet another aspect of the present disclosure includes: a starter configured to start an application including multiple blocks each having a parameter for controlling an apparatus including at least one of an actuator and a heater, and a sequence including one or more processes involving at least a motion of a person; a calculator configured to repeatedly calculate a first scheduled completion time of an N+1th block (N is an integer of 1 or more) of the application and a second scheduled completion time of an Mth process (M is an integer of 1 or more) of the sequence; a determination unit configured to determine whether the first scheduled completion time coincides with the second scheduled completion time; and an extension unit configured to extend an Nth block until the determination unit determines that the first scheduled completion time coincides with the second scheduled completion time.

The present configuration enables providing the information processing device that can obtain an effect similar to that of the information processing method described above.

The present disclosure can also be implemented as an information processing program for causing a computer to execute each characteristic configuration included in an information processing method as described above, or as an information processing system operated by the information processing program. It is needless to say that such a computer program can be distributed using a computer-readable non-transitory recording medium such as a CD-ROM, or via a communication network such as the Internet.

Each of embodiments described below illustrates a specific example of the present disclosure. Numerical values, shapes, components, steps, order of steps, and the like shown in the embodiments below are merely examples, and are not intended to limit the present disclosure. The components in the embodiments below includes a component that is not described in independent claims indicating the highest concept, and then the component is described as an optional component. In all the embodiments, respective contents can be combined.

### First Embodiment

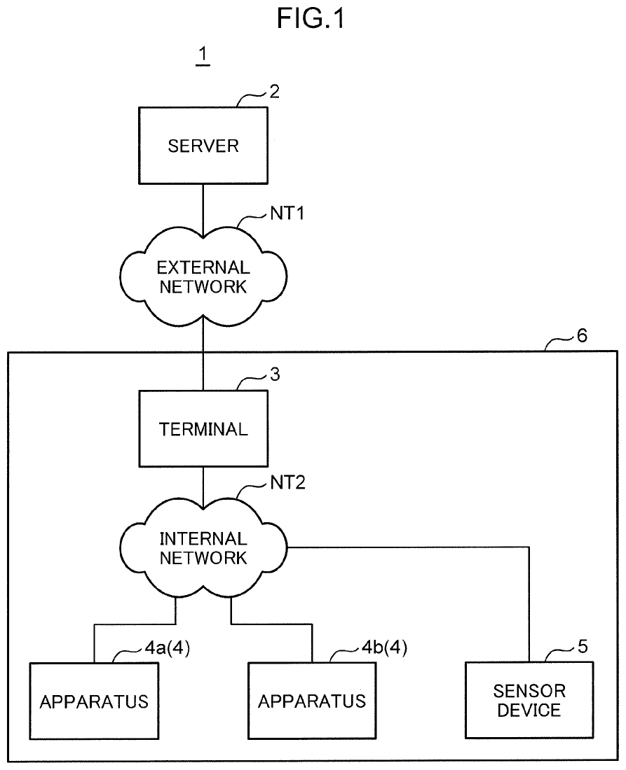

FIG. 1 is a diagram illustrating an example of a general configuration of an information processing system 1 according to a first embodiment of the present disclosure. The information processing system 1 includes a server 2, a terminal 3, an apparatus 4a, an apparatus 4b, and a sensor device 5. The server 2 and the terminal 3 are communicably connected to each other via an external network NT1. The external network NT1 includes a public communication network including the Internet and a mobile phone communication network, for example. The apparatus 4a and the apparatus 4b are collectively referred to as an apparatus 4.

The terminal 3, the apparatus 4, and the sensor device 5 are installed in a facility 6. The facility 6 is a house, for example. Examples of the house include a solitary house and an apartment house. The facility 6 may be a store or an office, for example.

The terminal 3, the apparatus 4, and the sensor device 5 are communicably connected to one another via an internal network NT2. The internal network NT2 includes a local area network including a wireless LAN and a wired LAN, for example. The internal network NT2 may include Bluetooth (registered trademark).

Although the information processing system 1 includes one facility 6 in the example of FIG. 1, the present disclosure is not limited thereto, and multiple facilities 6 may be included.

The server 2 includes a cloud server including one or more computers, for example. The apparatus 4 is an electric apparatus used in the facility 6. Examples of the electric apparatus include a home appliance (home electric appliance) and home equipment. Applicable examples of the home electric appliance include a microwave oven, a rice cooker, a mixer, an electric oven, an electric toaster, an electric pot, a hot plate, an induction heating (IH) cooker, a roaster, a bakery, an electric pressure pot, an electric anhydrous pot, a multi-cooker, a coffee maker, a refrigerator, a washing machine, a dishwasher, a vacuum cleaner, an air conditioner, a humidifier, a dryer, a fan, and an ion generator.

Applicable examples of the home equipment include an electric shutter, an electronic lock, and an electric water heater for a bathtub. Examples of the apparatus 4 are not limited thereto.

The sensor device 5 is a sensor for monitoring a motion of a user, and examples of the sensor include a camera and a microphone. The sensor device 5 is installed in a kitchen, a living room, and a lavatory in which a washing machine is installed, for example. Applicable examples of the sensor device 5 include an instrument capable of detecting a change in a state of an ingredient in accordance with a motion of the user. Examples of the instrument include a cutting board with a sensor that detects the number of times of cutting of an ingredient, a weight sensor that detects weight of an ingredient, and an electronic mill.

The terminal 3 may be a portable terminal such as a smartphone and a tablet terminal, or may be installed on a wall, a floor, or a ceiling of the facility 6. The terminal 3 functions as a gateway for connecting the external network NT1 and the internal network NT2.

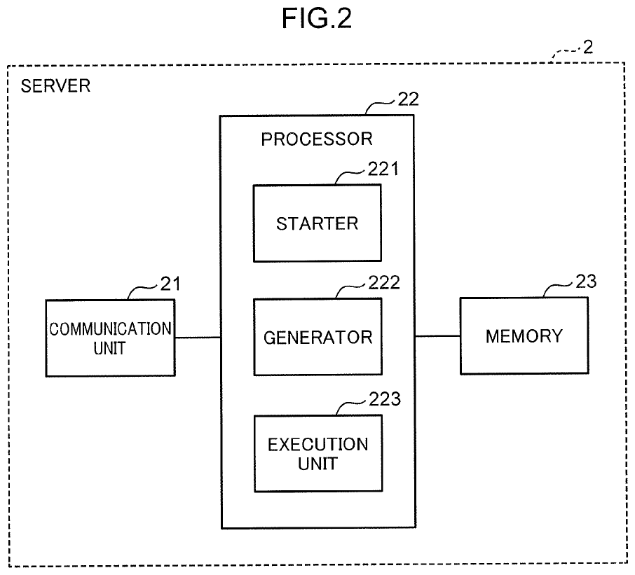

FIG. 2 is a block diagram illustrating an example of a configuration of the server 2 according to the first embodiment of the present disclosure. The server 2 includes a communication unit 21, a processor 22, and a memory 23. The communication unit 21 includes a communication circuit that connects the server 2 to the external network NT1. The communication unit 21 receives a start request for starting an application and a sequence from the terminal 3.

The processor 22 is configured by a CPU, for example, and includes a starter 221, a generator 222, and an execution unit 223. The starter 221 executes the application and the sequence at the same time in response to the start request received by the communication unit 21 as a trigger, for example. The start request includes information on an application and a sequence designated by a person. The processor 22 includes blocks each of which may be configured by an electric circuit.

The starter 221 transmits a start instruction for executing the application and the sequence at the same time to the terminal 3 using the communication unit 21. The starter 221 transmits an apparatus control signal for operating the apparatus 4 according to the application to the apparatus 4 using the communication unit 21. The starter 221 transmits an instruction signal to the terminal 3 using the communication unit 21, the instruction signal instructing a motion of the person requested to execute a process included in the sequence.

The application is a computer program including multiple blocks that are sequentially executed. The application is developed in advance by an application developer in association with each of one or more operation modes of the apparatus 4, for example. Examples of the one or more operation modes of a rice cooker include an operation mode for cooking cooked rice and an operation mode for cooking white rice, and the application exists for each of these operation modes. Examples of the one or more operation modes of washing machine include an operation mode of a standard course, an operation mode of a nice clothes washing course, and an operation mode of a big clothes washing course, and the application exists for each of these operation modes.

The application developer creates the application by using a development tool. The development tool is a program executed by a computer. The development tool has blocks prepared in advance. The application developer can easily create an application by inputting an operation of arranging the blocks prepared in advance in the development tool. For example, when creating an application for cooked rice, the application developer inputs an operation of arranging a block of pre-cooking processing, a block of ingredient inserting processing, and a block of cooking processing in order.

Each of the blocks includes a control program for controlling the apparatus 4 including at least one of an actuator and a heater, and shows the control program in an abstracted manner. Examples of blocks of the rice cooker include a block for controlling pre-cooking processing, a block for controlling ingredient inserting processing, and a block for controlling cooking processing. Examples of blocks of the washing machine include a block for controlling stirring processing, a block for controlling rinsing processing, and a block for controlling spin-drying processing.

Each block includes a parameter for controlling the apparatus 4 including at least one of an actuator and a heater. The parameter varies for each block. For example, the block of the pre-cooking processing in the rice cooker includes a parameter for specifying a set temperature of the rice cooker, a parameter for specifying a processing time, and the like. For example, the block of the stirring processing in the washing machine includes a parameter for specifying rotation speed of a motor, a parameter for specifying a water level, a parameter for specifying a processing time, and the like.

The sequence is a computer program including an instruction for implementing one or more processes involving at least a motion of a person. The sequence may include a process of instructing the apparatus 4 to operate in addition to a process involving the person. The sequence causes the terminal 3 to output instruction information indicating an instruction of a motion for a person, for example. The instruction information is output in a form such as at least one of video and voice. The person operates according to the instruction output from the terminal 3.

Examples of the process involving a motion of a person include a process of cutting vegetables, a process of frying the cut vegetables, a process of taking a meal, and a process of tidying up after taking the meal. These processes are prepared in advance in the development tool described above. The application developer develops the sequence by inputting an operation of arranging these processes in the development tool.

Each process includes a parameter defining contents. For example, the process of cutting vegetables includes a parameter defining the number of times of cutting, a parameter defining weight of the vegetables, and the like. For example, the process of taking a meal includes a parameter defining a meal time. For example, the process of tidying up after the meal includes a parameter defining a tidying time.

The application developer can also define a cooperation rule for causing a certain sequence to cooperate with a certain application in the development tool. Examples of the cooperation includes a case where the sequence is cooperated with the N+1th block of the application after completion of the Mth process of the sequence. Here, M and N are each an integer of 1 or more.

Here, the starter 221 is configured to simultaneously start the application and the sequence in which the cooperation rule is defined.

The generator 222 generates a state maintaining block having a parameter predetermined in accordance with a type of the Nth block to maintain a state of a processing object at the completion of the Nth block. When the apparatus 4 is a cooking apparatus, the processing object corresponds to ingredients cooked by the cooking apparatus up to the Nth process, for example. The parameter has a value determined based on sensing data acquired from a sensor 46. The state maintaining block may also have multiple parameters different in priority for maintaining a state of the apparatus 4.

When the completion of the Nth block is detected, the execution unit 223 executes the generated state maintaining block. When completion of the Mth process is detected during execution of the state maintaining block, the execution unit 223 causes the application to end the state maintaining block and execute the N+1th block.

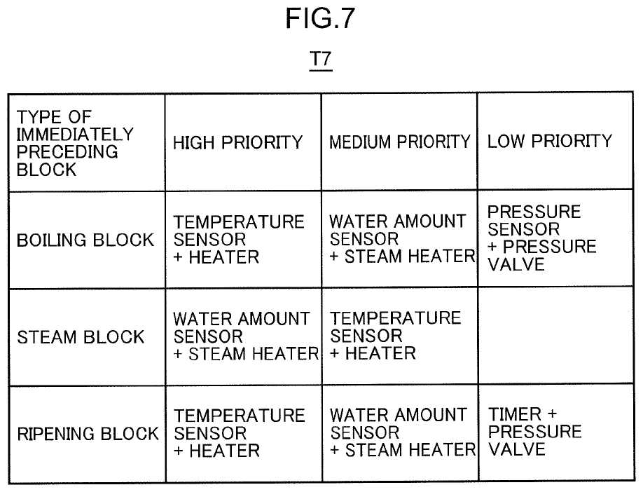

The memory 23 is includes a storage device such as a hard disk drive (HDD) and a solid state drive (SSD). The memory 23 preliminarily stores an application to be executed and a sequence. The memory 23 preliminarily stores a parameter table T7 illustrated in FIG. 7. Details of the parameter table T7 will be described later.

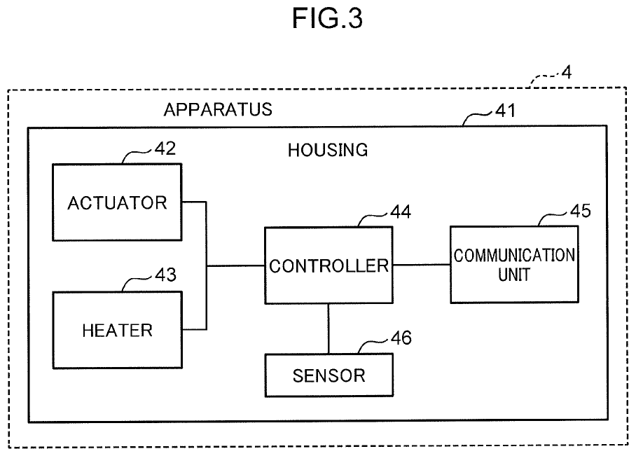

FIG. 3 is a block diagram illustrating an example of a configuration of the apparatus 4. The apparatus 4 includes a housing 41, an actuator 42, a heater 43, a controller 44, a communication unit 45, and the sensor 46. The apparatus 4 may include at least one of the actuator 42 and the heater 43. The housing 41 houses the actuator 42, the heater 43, the controller 44, the communication unit 45, and the sensor 46. The housing 41 may have an internal space for processing a processing object. Examples of the internal space include a washing tub of a washing machine, a heating chamber of a microwave oven, and an inner pot of a rice cooker.

The actuator 42 is a mechanical element that converts input energy into physical motion based on an electrical signal. Examples of the actuator 42 include an electric motor, a hydraulic cylinder, and a pneumatic actuator.

The heater 43 is an electric heater that converts electric energy into thermal energy. The heater 43 heats a processing object by Joule heating, induction heating, and dielectric heating, for example. Examples of the heater 43 include a nichrome wire, a coil, and a magnetron.

The controller 44 controls components of the apparatus 4, including the actuator 42 and the heater 43. The controller 44 includes an integrated circuit, for example. The controller 44 causes the apparatus 4 to operate in response to an apparatus control signal transmitted from the server 2.

The communication unit 45 includes a communication circuit that connects the apparatus 4 to the internal network NT2. The communication unit 45 receives an apparatus control signal transmitted from the server 2. The communication unit 45 transmits sensing data detected by the sensor 46 to the server 2.

The sensor 46 is configured to detect a state of the apparatus 4. Examples of the sensor 46 include a temperature sensor, a water amount sensor, and a pressure sensor. The sensor 46 detects a state of the apparatus 4 at a predetermined sampling period, for example, and generates sensing data indicating the detected state.

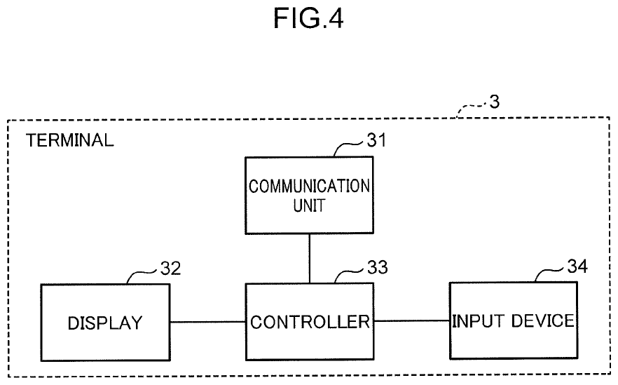

FIG. 4 is a block diagram illustrating an example of a configuration of the terminal 3. The terminal 3 includes a communication unit 31, a display 32, a controller 33, and an input device 34. The communication unit 31 includes a communication circuit that connects the terminal 3 to the internal network NT2. The communication unit 31 receives an instruction signal transmitted from the server 2. The communication unit 31 also transfers various data to the server 2, the various data being transmitted from the apparatus 4 and the sensor device 5 and addressed to the server 2. The communication unit 31 further transfers data to the apparatus 4, the data being transmitted from the server 2 and addressed to the apparatus 4.

The display 32 includes an organic EL display or a liquid crystal display. The display 32 displays instruction information indicating an instruction to a person based on the instruction signal.

The controller 33 controls the terminal 3. The controller 33 includes an integrated circuit, for example. The controller 33 generates instruction information based on an instruction signal transmitted from the server 2 and causes the display 32 to display the instruction information.

Applicable examples of the input device 34 include a touch panel, a keyboard, and a mouse. As the input device 34, a voice input device may be used. The input device 34 and the display 32 may be integrally formed as a touch screen. The input device 34 may be a gesture input device. The gesture input device includes a camera and a recognizer, for example. The camera captures an image including a gesture, and the recognizer recognizes the gesture using the image.

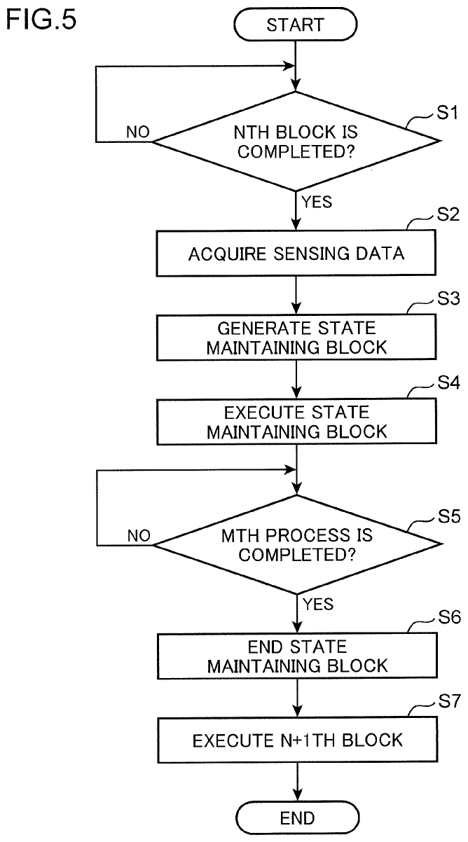

FIG. 5 is a flowchart illustrating an example of processing of the server 2 according to the first embodiment of the present disclosure. This flowchart starts during execution of the Nth block.

In step S1, the execution unit 223 detects completion of the Nth block. The execution unit 223 may detect that the Nth block is completed when the Nth block satisfies a predetermined completion condition. Applicable examples of the completion condition include at least one of a condition that execution time of the block exceeds a predetermined time, a condition that the internal space has a temperature reaching to a predetermined temperature, and a condition that the internal space has a humidity reaching to a predetermined humidity can be adopted. When the completion of the Nth block is detected (YES in step S1), the processing proceeds to step S2, and when the completion of the Nth block is not detected (NO in step S1), the processing waits in step S1.

In step S2, the generator 222 acquires sensing data on the apparatus 4 at the completion of the Nth block. For example, the sensing data includes at least one of temperature and humidity of the internal space of the apparatus 4.

In step S3, the generator 222 generates the state maintaining block based on the parameter table T7 illustrated in FIG. 7 and the sensing data acquired in step S2. For example, the generator 222 may generate the state maintaining block having parameters defined in the parameter table T7, the parameters each having a value determined based on the sensing data.

In step S4, the execution unit 223 executes the generated state maintaining block. In this case, an apparatus control signal for executing the state maintaining block is transmitted to the apparatus 4.

In step S5, the execution unit 223 detects completion of the Mth process. Here, the execution unit 223 may detect completion of the Mth process when the Mth process satisfies a predetermined completion condition. For example, the execution unit 223 may analyze a motion of a person from the sensing data, and may determine that the Mth process is completed when the analyzed motion indicates a motion different from the motion defined by the Mth process.

When the completion of the Mth process is detected (YES in step S5), the execution unit 223 ends the state maintaining block (step S6). When the completion of the Mth process is not detected (NO in step S5), the execution unit 223 causes the processing to wait in step S5. In this case, an apparatus control signal for ending the state maintaining block is transmitted to the apparatus 4.

In step S7, the execution unit 223 executes the N+1th block. In this case, an apparatus control signal for executing N+1th block is transmitted to the apparatus 4.

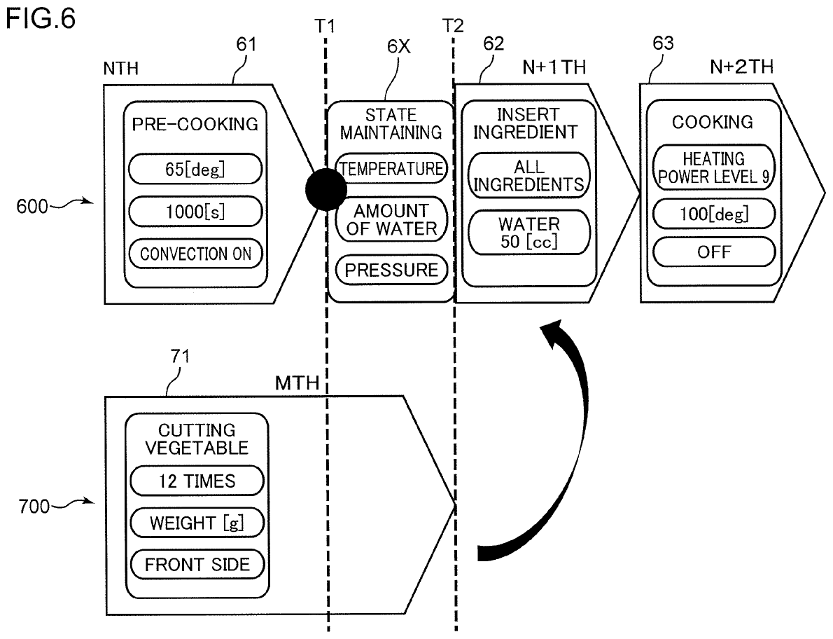

FIG. 6 is a sequence diagram illustrating execution of a state maintaining block 6X in the first embodiment of the present disclosure. This example shows an application 600 in which a rice cooker serving as the apparatus 4 cooks cooked rice, and a sequence 700 for preparation of the cooked rice.

The application 600 includes an Nth block 61 of pre-cooking processing, an N+1th block 62 of ingredient inserting processing, and an N+2th block 63 of cooking processing. The sequence 700 includes an Mth process 71 of cutting a vegetable.

The application 600 and the sequence 700 follow a cooperation rule defined to cooperate the sequence 700 with the block 62 after completion of the block 61. FIG. 6 illustrates cooperation in which the vegetable cut in the process 71 are put into a cooking apparatus. FIG. 6 does not illustrate an N−1th and previous blocks and an M−1th and previous processes.

For example, the block 61 includes a parameter defining a set temperature, a parameter indicating a processing time, and a parameter defining convection ON. For example, step 71 includes a parameter that defines the number of times of cutting, a parameter that defines weight of an ingredient to be cut, and the like.

At timing T1, the execution unit 223 detects completion of the block 61. Here, the processing time of the block 61 has reached 1000 s, so that the completion of the block 61 is detected.

At the timing T1, the generator 222 generates the state maintaining block 6X having parameters predetermined in accordance with a type of the block 61. This example shows the state maintaining block 6X that includes a parameter defining a set temperature, a parameter defining the amount of water, and a parameter defining a pressure.

At the timing T1, the execution unit 223 executes the state maintaining block 6X. In this case, the execution unit 223 determines a value of each parameter of the state maintaining block 6X based on sensing data acquired from the rice cooker at the timing T1.

At timing T2, the execution unit 223 detects completion of the process 71. For example, when sensing data acquired by a camera and/or a microphone is used as sensing data acquired by the sensor device 5, the execution unit 223 may detect that the process 71 is completed when a motion of the person indicated by the sensing data acquired from the camera is changed to a motion different from that of the vegetable cutting. For example, when sensing data acquired by the instrument described above is used as the sensing data acquired by the sensor device 5, the execution unit 223 may count the number of cuts of an ingredient vegetable from the sensing data, and may determine that the process 71 is completed when the number of counts reaches a predetermined number of times (here, 12 times).

At the timing T2, the execution unit 223 ends the state maintaining block 6X and executes the block 62.

Completion timing (timing T2) of the process 71 is delayed from completion timing of block 61 due to skill of the person cutting vegetables. In this case, stopping operation of the cooking apparatus in a period from the timing T1 to the timing T2 causes a processing object to be cooled or dried, and thus deteriorating quality of the processing object. This case deteriorates quality of the cooked rice.

Thus, the present embodiment causes the state maintaining block 6X to be executed in the period from the timing T1 to the timing T2. Here, the state maintaining block 6X has parameters for maintaining a state of the processing object at the completion of the block 61. Thus, the present embodiment enables suppressing deterioration in quality of the processing object and suppressing deterioration in quality of the cooked rice at the timing T2 at which the block 62 starts.

Next, parameters of the state maintaining block 6X will be described. The generator 222 determines the parameters of the state maintaining block 6X with reference to the parameter table T7 illustrated in FIG. 7. FIG. 7 is a diagram illustrating an example of a data configuration of the parameter table T7.

The parameter table T7 has a vertical axis representing an immediately preceding block of the state maintaining block 6X, and a horizontal axis representing a priority.

This example shows a boiling block, a steam block, and a ripening block, as the immediately preceding block. This example also shows three priorities of high, medium, and low. The parameter table T7 has cells in which the corresponding parameters of the state maintaining block are registered.

The boiling block of the immediately preceding block has a parameter of “temperature sensor+heater” registered as a parameter with the high priority, a parameter of “water amount sensor+steam heater” registered as a parameter with the medium priority, and a parameter of “pressure sensor+pressure valve” registered as a parameter with the low priority.

The parameter of “temperature sensor+heater” is for controlling the heater, and has a value determined based on a temperature value detected by the temperature sensor. The parameter of “water amount sensor+steam heater” is for controlling the steam heater, and has a value determined based on the amount of water detected by the water amount sensor. The parameter of “pressure sensor+pressure valve” is for controlling the pressure valve, and has a value that is an opening degree value of the pressure valve determined based on the pressure value detected by the pressure sensor.

The generator 222 generates a state maintaining block including all the parameters registered in one row of the parameter table T7. For example, the generator 222 generates a state maintaining block having three parameters registered in the first row for the state maintaining block of the boiling block.

The execution unit 223 first executes a parameter with the high priority to start the state maintaining block. Next, the execution unit 223 further executes a parameter with the medium priority when the apparatus 4 has power consumption equal to or less than a predetermined upper limit amount of power when a predetermined time elapses after the parameter with the high priority is executed. Subsequently, the execution unit 223 further executes a parameter with the low priority when the apparatus 4 has the power consumption equal to or less than the predetermined upper limit amount of power when a predetermined time elapses after the parameter with the medium priority is executed.

The apparatus 4 has the power consumption that is during execution of the state maintaining block, for example. The execution unit 223 may calculate the power consumption based on the sensing data transmitted from the apparatus 4.

For example, the boiling block is configured such that water is evaporated while heat is applied to ingredients by the heater. Thus, to maintain a state at completion of the boiling block, temperature management of the internal space is most important. The parameter table T7 accordingly shows the parameter of “temperature sensor+heater” with the priority set to be high. For example, when the temperature sensor detects a temperature of 130 degrees at the completion of the boiling block, the execution unit 223 may set a value of the parameter of “temperature sensor+heater” to 130 degrees. Alternatively, the execution unit 223 may set the value of the parameter of “temperature sensor+heater” to 100 degrees to suppress a decrease in the amount of water in the ingredients during the execution of the state maintaining block.

When control using the parameter of “temperature sensor+heater” is further continued, the amount of water in the ingredients may decrease. Thus, the parameter of “water amount sensor+steam heater” has the priority set to medium. Executing this parameter causes steam to be applied to the internal space, so that the amount of water of the ingredients is maintained.

The boiling block may be configured such that control of moving an ingredient with pressure is performed. Thus, to maintain this state, the parameter of “pressure sensor+pressure valve” has the priority set to be low.

Although the state maintaining block having the immediately preceding block of the boiling block has been described here in detail, an appropriate parameter for maintaining the state of the ingredients at completion of the immediately preceding block is also registered in the parameter table T7 for each of the state maintaining blocks of the ripening block and the ripening block.

The parameters of the state maintaining block registered in the parameter table T7 and the priority of each parameter may be defined by a manufacturer of the apparatus 4 or may be defined by a developer of the application.

The developer of the application may also define a control rule based on the parameter table T7 defined by the manufacturer. Applicable examples of the control rule include a rule of executing a parameter with a medium priority in addition to a parameter with a high priority when a pot bottom of the cooking apparatus has a temperature of 130 degrees at completion of the immediately preceding block. The applicable examples of the control rule may include a rule of adding a stirring parameter in a state maintaining block of warming ingredients.

Although the example of FIG. 7 shows the parameters related to the cooking apparatus, the parameter table T7 also includes parameters registered for another apparatus 4.

Although in the above description, the parameter to be executed is determined in accordance with power consumption, the present disclosure is not limited thereto. For example, a cooking apparatus having two or more heaters may be configured such that the execution unit 223 alternately executes a parameter of a heater having a high priority and a parameter of a heater having a medium priority. For example, the execution unit 223 may alternately execute the parameter of the heater having the high priority and the parameter of the heater having the medium priority in a time distribution of “3:2”. Specifically, the execution unit 223 may repeatedly execute a control set of first executing the parameter of the heater having the high priority for 3 minutes and then executing the parameter of the heater having the medium priority for 2 minutes.

As described above, even when the Mth process is delayed due to skill of a person, the first embodiment causes the state of the apparatus 4 at completion of the Nth block to be maintained, thereby enabling suppression of deterioration in quality of the processing object of the apparatus 4. Additionally, the state maintaining block is generated based on the sensing data acquired from the sensor of the apparatus 4, so that a state maintaining block appropriate for maintaining the state of the apparatus 4 can be generated.

### Second Embodiment

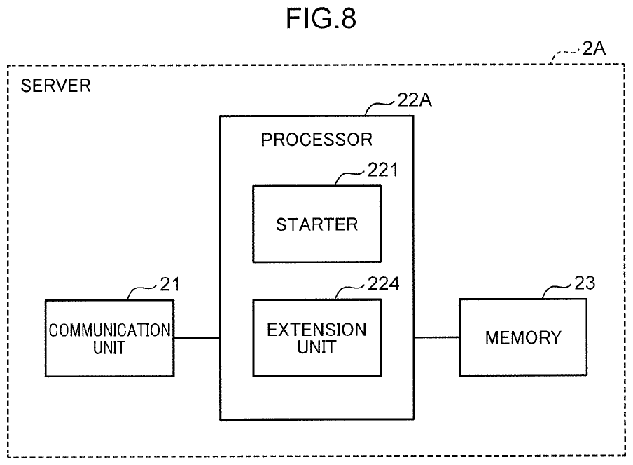

A second embodiment is different from the first embodiment in that the Nth block is extended instead of generating the state maintaining block. FIG. 8 is a block diagram illustrating an example of a configuration of a server 2A according to the second embodiment of the present disclosure. In the second embodiment, the same components as those in the first embodiment are denoted by the same reference numerals, and description thereof will be omitted.

The server 2A includes a processor 22A. The processor 22A includes a starter 221 and an extension unit 224. The extension unit 224 extends the Nth block until the Mth process is completed.

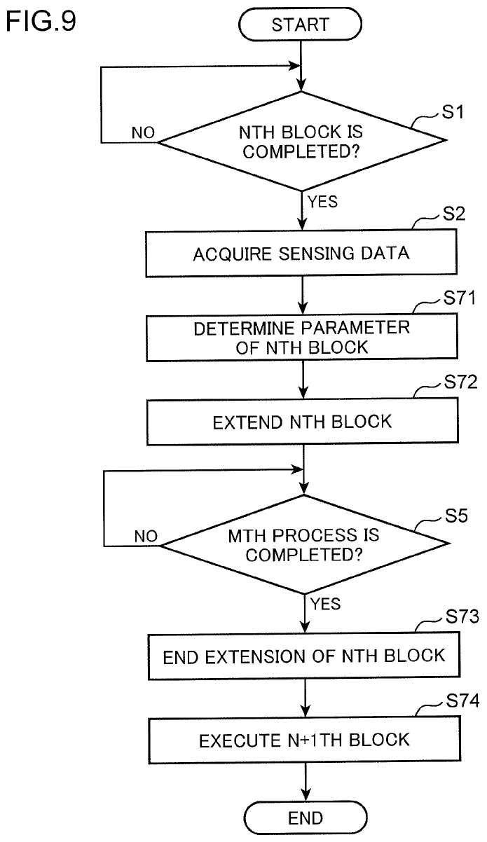

FIG. 9 is a flowchart illustrating an example of processing of the server 2A according to the second embodiment of the present disclosure. In the flowchart of FIG. 9, the same processing as those in FIG. 5 are denoted by the same reference numerals.

In step S71 subsequent to step S2, the extension unit 224 determines a parameter of the Nth block during extension based on the parameter table T7 illustrated in FIG. 7 and the sensing data acquired in step S2. Details of determination of this parameter are the same as those in the first embodiment, and thus description thereof is omitted.

In step S72, the extension unit 224 updates the parameter of the Nth block with the parameter determined in step S71, and extends the Nth block with the parameter updated.

When detecting completion of the Mth process (YES in step S5) in step S5, the extension unit 224 ends the extension of the Nth block (step S73). In step S74, the extension unit 224 executes the N+1th block.

As described above, even when the Mth process is delayed due to skill of a person, the second embodiment causes the state of the apparatus 4 at completion of the Nth block to be maintained, thereby enabling suppression of deterioration in quality of the processing object of the apparatus 4.

Although the parameter of the Nth block is updated with the parameter determined in step S71 in the second embodiment, and then the Nth block is extended, this is an example, and the Nth block may be extended without updating the parameter of the Nth block with the parameter determined in step S71. This case causes the processing of steps S1, S2, S71, and S72 to be unnecessary, so that a processing load can be reduced.

### Third Embodiment

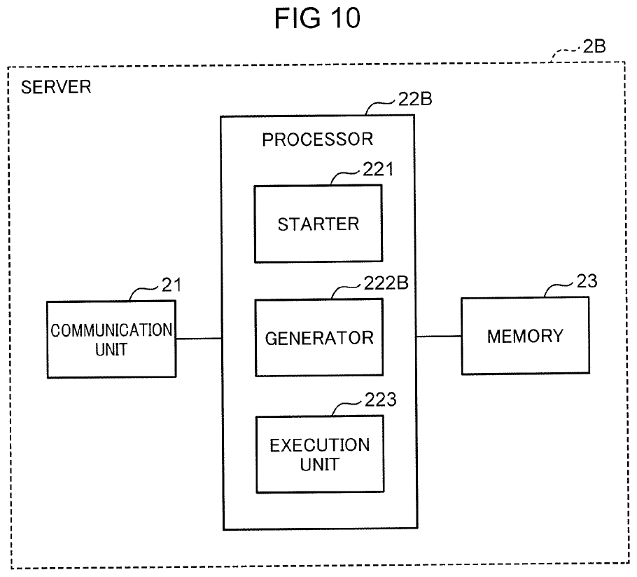

A third embodiment causes a state maintaining block to be generated based on delays in processes up to the M−1th process. FIG. 10 is a block diagram illustrating an example of a configuration of a server 2B according to the third embodiment of the present disclosure. In the present embodiment, the same components as those in the first embodiment are denoted by the same reference numerals, and description thereof will be omitted.

The server 2B includes a processor 22B. The processor 22B includes a starter 221, a generator 222B, and an execution unit 223. The generator 222B generates a state maintaining block when detecting delays in processes up to the M−1th process.

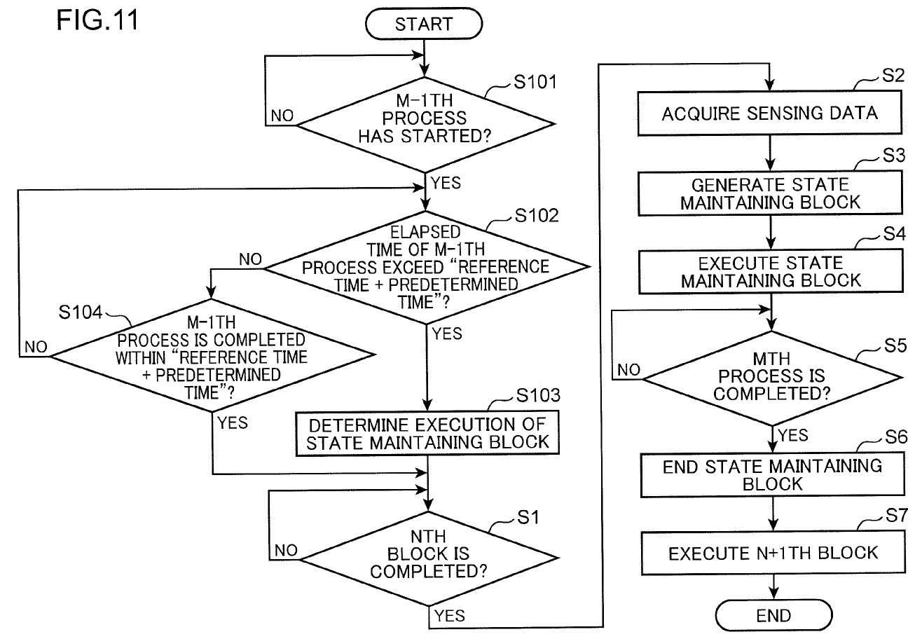

FIG. 11 is a flowchart illustrating an example of processing of the server 2B according to the third embodiment of the present disclosure. In the flowchart of FIG. 11, the same processing as those in FIG. 5 are denoted by the same reference numerals, and description thereof is omitted.

In step S101, the execution unit 223 detects a start of the M−1th process. When the start of the M−1th process is detected (YES in step S101), the processing proceeds to step S102, and when the start of the M−1th process is not detected (NO in step S101), the processing waits in step S101. Here, the execution unit 223 may detect completion of the M−1 th process when the M−1 th block satisfies a predetermined completion condition. For example, when sensing data acquired by a camera and/or a microphone is used as sensing data acquired by the sensor device 5, the execution unit 223 may analyze a motion of a person from the sensing data, and may determine that the M−1th process is completed when the analyzed motion indicates a motion different from that defined by the M−1th process. For example, when sensing data acquired by the instrument described above is used as the sensing data acquired by the sensor device 5, the execution unit 223 may count the number of cuts of a vegetable from the sensing data, and may determine that the M−1th process is completed when the number of counts reaches a predetermined number of times (here, 12 times).

In step S102, the generator 222B determines whether elapsed time of the M−1th process exceeds a time obtained by adding a predetermined time to a reference time. The elapsed time is based on a start time of the M−1th process. The reference time is a predetermined time expected to be required to complete the M−1th process, for example. The predetermined time is one minute, for example. The predetermined time is provided to give a margin to criteria.

When the determination in step S102 is YES, the generator 222B determines to execute the state maintaining block (step S103). When the determination in step S102 is NO, the generator 222B determines whether the M−1th process is completed within a total of the reference time and the predetermined time (step S104). When the M−1th process is completed within the total of the reference time and the predetermined time (YES in step S104), the processing proceeds to step S1. In contrast, when the M−1th process is not completed within the total of the reference time and the predetermined time (NO in step S104), the processing returns to step S102.

Thereafter, the processing of steps S1 to S7 is executed as in FIG. 5. As a result, when the Nth process is completed, the state maintaining block is executed, and when the Mth process is completed, the state maintaining block is terminated and the N+1th block is executed.

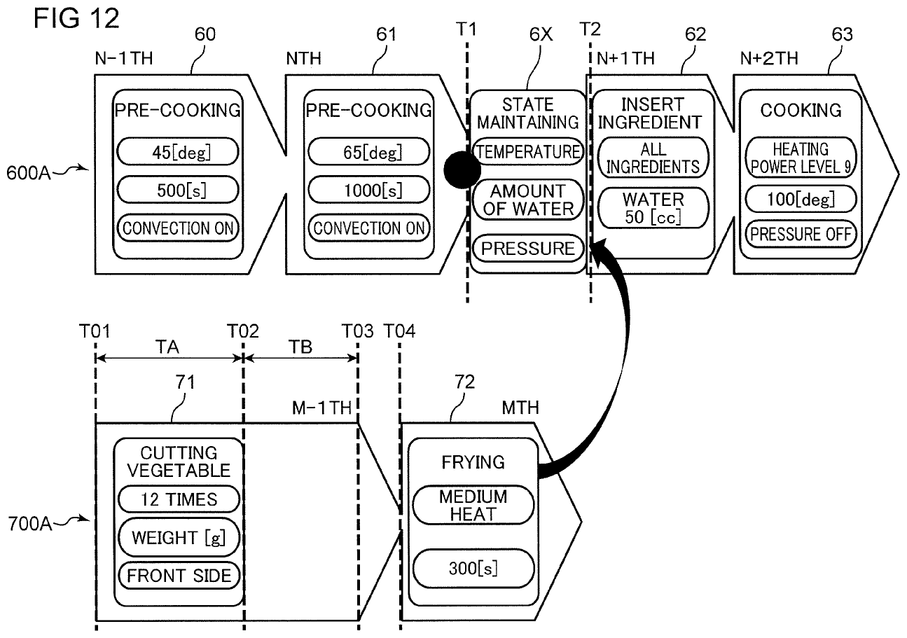

FIG. 12 is a sequence diagram illustrating execution of a state maintaining block 6X in the third embodiment of the present disclosure. This example shows an application 600A in which a rice cooker serving as the apparatus 4 cooks cooked rice, and a sequence 700A for preparation of the cooked rice.

The application 600A includes an N−1th block 60 of first pre-cooking processing, an Nth block 61 of second pre-cooking processing, an N+1th block 62 of ingredient inserting processing, and an N+2th block 63 of cooking processing. The sequence 700A includes an M−1th process 71 of cutting a vegetable, and an Mth process 72 of frying the cut vegetable.

The application 600A and the sequence 700A follow a cooperation rule defined to cooperate the sequence 700A with the block 62 after completion of the Nth block 61. FIG. 12 illustrates cooperation in which a fried cut vegetable obtained in the Mth process 72 is put into a cooking apparatus. FIG. 12 does not illustrate an N−2th and previous blocks and an M−2th and previous processes.

For example, the process 72 includes a parameter that defines heating power of a cooking stove and a parameter that defines frying time.

The M−1th process is started at timing T01, and then the generator 222B starts counting elapsed time of the M−1th process. At timing T02, the elapsed time of the M−1th process reaches reference time TA. At timing T03, the elapsed time of the M−1th process exceeds a total of reference time TA and predetermined time TB. Thus, the generator 222B determines execution of the state maintaining block at timing T03.

At timing T04, the M−1th process 71 is completed, and the Mth process 72 is started.

At timing T1, the execution unit 223 detects completion of the block 61. Here, the processing time of the block 61 has reached 1000 s, so that the completion of the block 61 is detected.

At the timing T1, the generator 222 generates the state maintaining block 6X having parameters predetermined in accordance with a type of the block 61. This example shows the state maintaining block 6X that includes a parameter defining a set temperature, a parameter defining the amount of water, and a parameter defining a pressure of the pressure valve.

At the timing T1, the execution unit 223 executes the state maintaining block 6X. In this case, the execution unit 223 determines a value of each parameter of the state maintaining block 6X based on sensing data acquired from the rice cooker at the timing T1.

At timing T2, the execution unit 223 detects completion of the process 72. The completion of the process 72 is detected here because the motion of the person indicated by the sensing data acquired from the sensor device 5 has changed to a motion different from a motion of frying. At the timing T2, the execution unit 223 ends the state maintaining block 6X and executes the block 62.

As described above, the third embodiment causes generation of the state maintaining block to be determined when a delay of the M−1th process is detected. Thus, when a delay of the Mth process is obvious due to the delay of the M−1th process before the Mth process is started, the generation of the state maintaining block can be determined.

### Fourth Embodiment

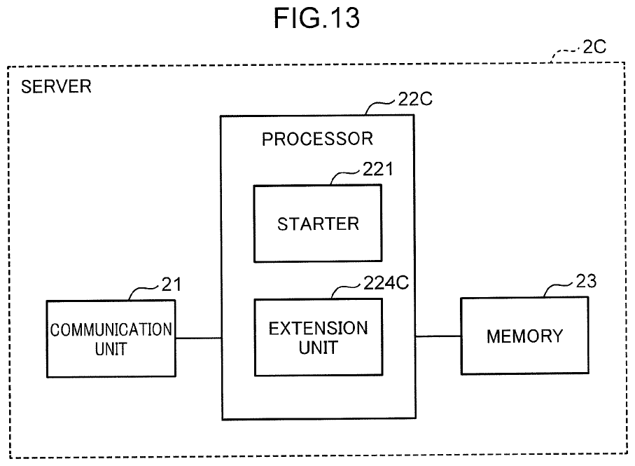

A fourth embodiment is different from the third embodiment in that the Nth block is extended instead of generating the state maintaining block. FIG. 13 is a block diagram illustrating an example of a configuration of a server 2C according to the fourth embodiment of the present disclosure. In the fourth embodiment, the same components as those in the first to third embodiments are denoted by the same reference numerals, and description thereof will be omitted.

The server 2C includes a processor 22C. The processor 22C includes a starter 221 and an extension unit 224C. When detecting a delay of the M−1th process, the extension unit 224C determines extension of the Nth block.

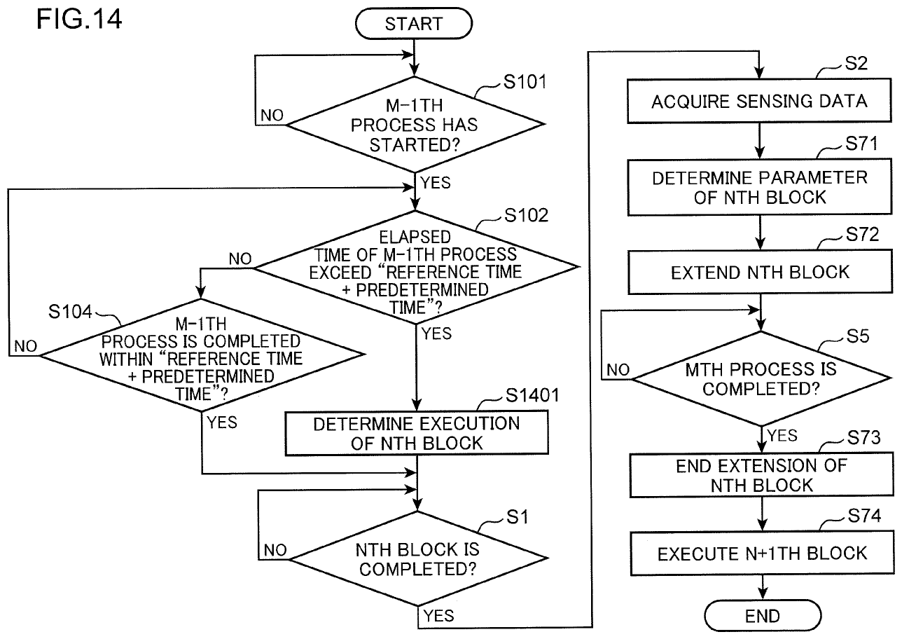

FIG. 14 is a flowchart illustrating an example of processing of the server 2C according to the fourth embodiment of the present disclosure. In the flowchart of FIG. 14, the same processing as those in FIGS. 9 and 11 are denoted by the same reference numerals, and description thereof is omitted.

When it is determined in step S102 that an elapsed time of the M−1th process exceeds a time obtained by adding a predetermined time to a reference time (YES in step S102), a generator 222C determines to extend the Nth block (step S1401). Thereafter, processing of steps S1, S2, S71, S72, S5, S73, and S74 is executed. As a result, the Nth block is extended until the Mth process is completed.

As described above, the fourth embodiment causes the extension of the Nth block to be determined when the delay of the M−1th process is detected. Thus, when a delay of the Mth process is obvious due to the delay of the M−1th process before the Mth process is started, the extension of the Nth block can be determined.

### Fifth Embodiment

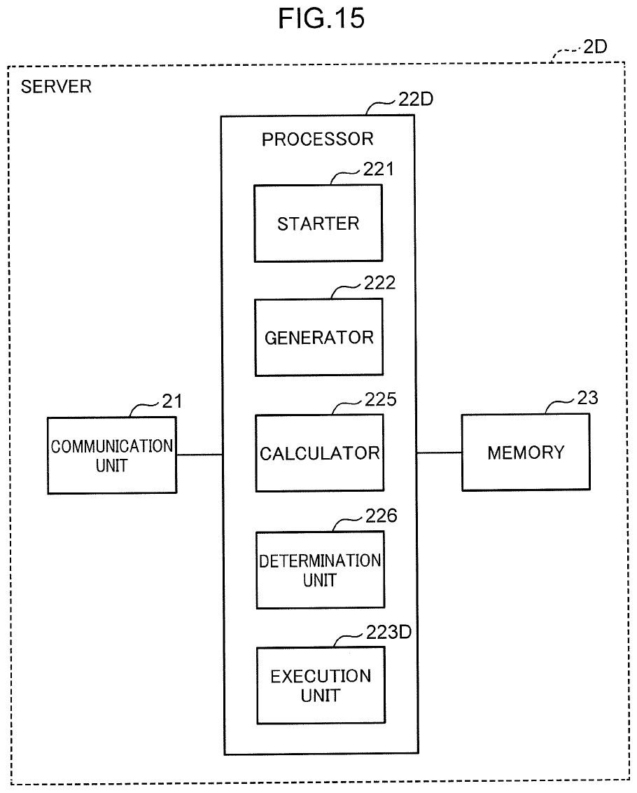

A fifth embodiment causes an application and a sequence to cooperate with each other to be completed at the same timing. FIG. 15 is a block diagram illustrating an example of a configuration of a server 2D according to the fifth embodiment of the present disclosure. In the fifth embodiment, the same components as those in the first to fourth embodiments are denoted by the same reference numerals, and description thereof will be omitted.

The application and the sequence according to the present embodiment follow a cooperation rule determined in advance to cause the N+1th block and the Mth process to be identical in scheduled completion time.

The server 2D includes a processor 22D. The processor 22D includes a starter 221, a generator 222, a calculator 225, a determination unit 226, and an execution unit 223D.

The calculator 225 calculates a first scheduled completion time of the N+1th block of the application and a second scheduled completion time of the Mth process of the sequence. For example, the calculator 225 may calculate the first scheduled completion time and the second scheduled completion time at a predetermined sampling period from when a start of a block (e.g., the M−1th block) before the Mth process by predetermined blocks is detected until the first scheduled completion time coincides with the second scheduled completion time.

The application includes blocks for controlling the apparatus 4, and thus each of the blocks has a reference time predetermined. Thus, the calculator 225 may calculate the first scheduled completion time by adding a total time of a remaining time of a block currently executed and reference times predetermined for the respective blocks from a block to be subsequently executed to the N+1th block to the current time. After the state maintaining block is executed, the calculator 225 may calculate the latest first scheduled completion time by adding elapsed time of the state maintaining block to the first scheduled completion time calculated at the start of the state maintaining block.

The calculator 225 may also calculate the second scheduled completion time as follows. The calculator 225 may calculate the second scheduled completion time by adding a total time of a remaining time of a process currently executed and reference times predetermined for respective processes from a process to be subsequently executed to the Mth process to the current time. The remaining time is calculated for a process currently executed by subtracting elapsed time of the process from a reference time predetermined for the process, for example. Alternatively, the calculator 225 may monitor a motion of a person from sensing data detected by the sensor device 5 and calculate the second scheduled completion time based on a monitor result.

The determination unit 226 determines whether the first scheduled completion time and the second scheduled completion time calculated by the calculator 225 coincide with each other.

The execution unit 223D executes the state maintaining block until the determination unit 226 determines that the first scheduled completion time coincides with the second scheduled completion time.

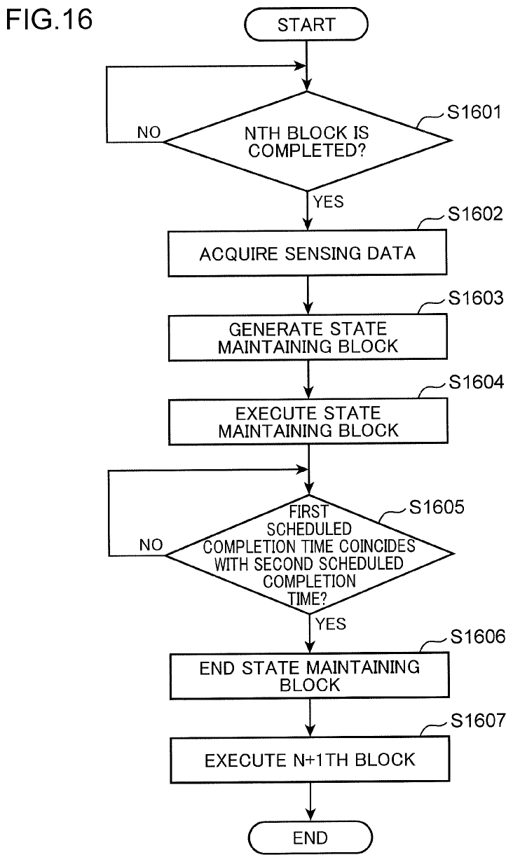

FIG. 16 is a flowchart illustrating an example of processing of the server 2D according to the fifth embodiment of the present disclosure. This flowchart starts during execution of the Nth block. This flowchart is performed after the Nth block is completed. In step S1601, the execution unit 223D detects completion of the Nth block. Details of the detection of the completion of the Nth block are the same as those in step S1 of FIG. 5.

In step S1602, the generator 222D acquires sensing data on the apparatus 4 at the completion of the Nth block. For example, the sensing data includes at least one of temperature and humidity of the internal space of the apparatus 4.

In step S1603, the generator 222D generates the state maintaining block based on the parameter table T7 illustrated in FIG. 7 and the sensing data acquired in step S2. Details of the processing in step S1603 are the same as those in the first embodiment.

In step S1604, the generator 222D executes the state maintaining block.

In step S1605, the determination unit 226 determines whether the first scheduled completion time coincides with the second scheduled completion time. When determination is made that the first scheduled completion time coincides with the second scheduled completion time (YES in step S1605), the processing proceeds to step S1606, and when determination is made that the first scheduled completion time does not coincide with the second scheduled completion time (NO in step S1605), the processing waits in step S1605.

In step S1606, the execution unit 223D ends the state maintaining block. In step S1607, the execution unit 223D executes the N+1th block.

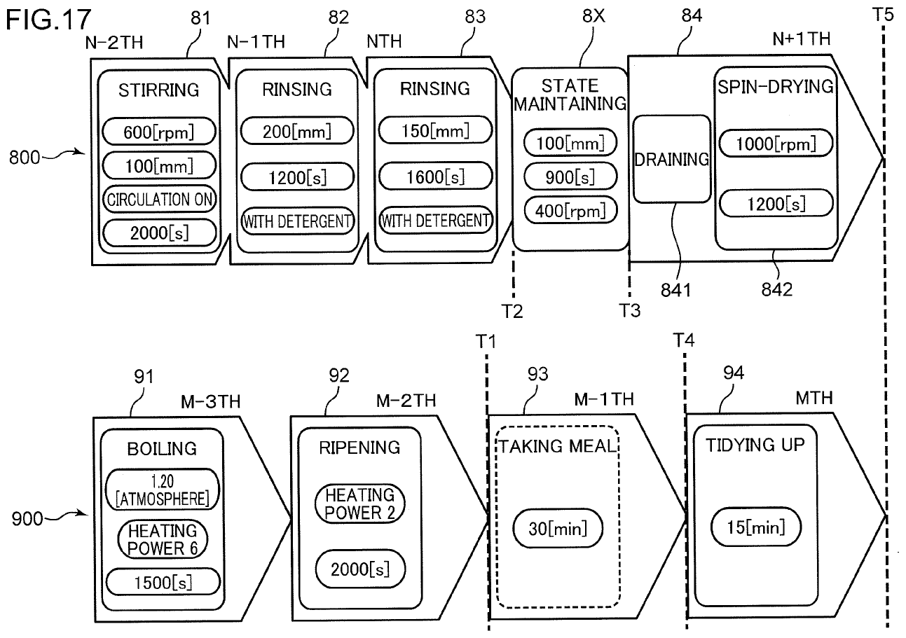

FIG. 17 is a sequence diagram illustrating execution of a state maintaining block 6X in the fifth embodiment of the present disclosure. FIG. 17 shows an example in which an application 800 is configured to cause a washing machine as the apparatus 4 to execute washing processing of a standard course. A sequence 900 includes cooking, taking a meal, and tidying up.

The application 800 includes an N−2th block 81 of stirring processing, an N−1th block 82 of first rinsing processing, an Nth block 83 of second rinsing processing, and an N+1th block 84 of spin-drying processing. The block 84 includes a sub-block 841 of draining processing and a sub-block 842 of spin-drying processing.

The sequence 900 includes an M−3th process 91 of causing a rice cooker to execute boiling processing, an M−2th process 92 of causing the rice cooker to execute ripening processing, an M−1th process 93 of taking a meal, and an Mth process 94 of tidying.

As described above, the sequence 900 includes not only a process of instructing a person to perform a motion as with the processes 93 and 94 but also a process of operating the apparatus 4 as with the processes 91 and 92.

At timing T1, the execution unit 223D detects the end of the process 92, and thus starts the process 93. The calculator 225 accordingly starts calculation processing of the first scheduled completion time and the second scheduled completion time. The process 93 is a process of taking a meal, so that the sequence causes the display 32 of the terminal 3 to display instruction information instructing a person to take a meal.

The calculator 225 may calculate the first scheduled completion time by adding a total time of a remaining time of a reference time of the block 83 and a reference time of the block 84 to the current time.

The calculator 225 may calculate the second scheduled completion time by adding a total time of a reference time of the process 93 and a reference time of the process 94 to the current time.

At timing T2, the generator 222D detects completion of the block 83, and thus generates a state maintaining block 8X. At the timing T2, the execution unit 223D then executes the generated state maintaining block 8X. Thereafter, the calculator 225 calculates the latest first scheduled completion time by adding elapsed time of the state maintaining block 8X to the first scheduled completion time calculated at the timing T1. Processing of calculating the latest first scheduled completion time is repeatedly executed at a predetermined sampling period.

At timing T3, the determination unit 226 determines that the first scheduled completion time coincides with the second scheduled completion time. Thus, the execution unit 223D ends the state maintaining block 8X and executes the block 84. The execution unit 223D here executes the sub-block 841.

At timing T4, the execution unit 223D detects completion of the process 93, and thus executes the process 94. The execution unit 223D may determine that the process 93 is completed, when the process 93 satisfies a predetermined completion condition based on the sensing data detected by the sensor device 5, for example. The completion condition corresponds to that a person performs a motion different from that of taking a meal, for example.

At timing T5, the block 84 and the process 94 are completed.

The state maintaining block 8X in the example of FIG. 17 is executed to cause the block 84 and the process 94 to be identical in scheduled completion time. The state maintaining block 8X here has parameters that are determined to maintain a state of a processing object (laundry in a washing tub) at the completion of the block 83.

When water in the washing tub is immediately drained after completion of the rinsing processing shown in the block 83 and the spin-drying processing shown in the sub-block 842 is executed after the laundry is left for a while, the laundry may be wrinkled or may cause an unpleasant odor.

Thus, in the present embodiment, the state maintaining block 8X is executed. The state maintaining block 8X in this example has a parameter for defining a water level, being set to 100 mm, a parameter for defining processing time, being set to 900 s, and a parameter for defining rotation speed of a motor for rotating the washing tub, being set to 400 rpm. The parameter of 900 s that defines the processing time is extended as needed until the first scheduled completion time coincides with the second scheduled completion time.

Thus, a state of the laundry at the completion of the block 83 is maintained in the period from the timing T2 to the timing T3. As a result, the block 84 and the process 94 can be identical in completion time without deterioration in quality of the processing object.

The block 84 in the example of FIG. 17 may be a final block or a block in the middle of the application 800. The process 94 in FIG. 17 may be a final process or a process in the middle.

As described above, the fifth embodiment causes the state maintaining block to be executed when the first scheduled completion time does not coincide with the second scheduled completion time. Thus, even when processes up to the Mth process are delayed, the state of the processing object at completion of the Nth block is maintained, and thus enabling completion time of the N+1th block to coincide with completion time of the Mth process while suppressing deterioration in quality of the processing object.

### Sixth Embodiment

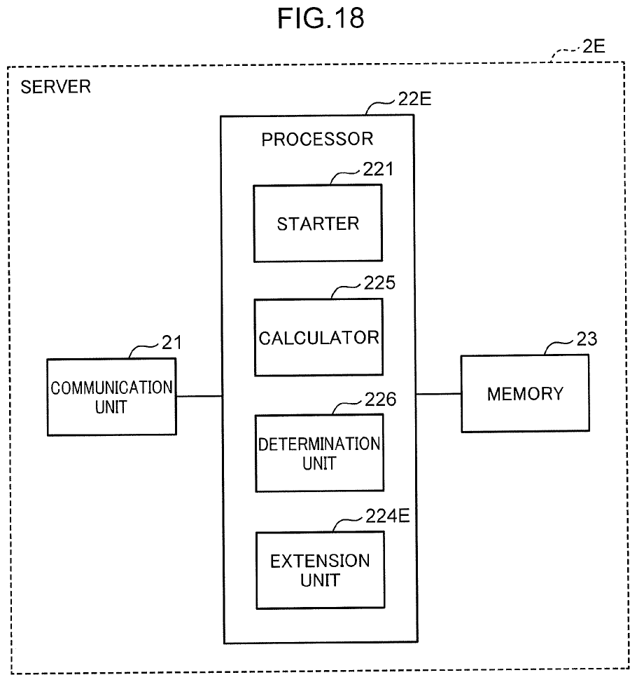

A sixth embodiment is different from the fifth embodiment in that the Nth block is extended instead of extending the state maintaining block. FIG. 18 is a block diagram illustrating an example of processing of a server 2E according to the sixth embodiment. In the sixth embodiment, the same components as those in the first to fifth embodiments are denoted by the same reference numerals, and description thereof will be omitted.

The server 2E includes a processor 22E. The processor 22E includes a starter 221, a calculator 225, a determination unit 226, and an extension unit 224E.

The extension unit 224E extends the Nth block until the determination unit 226 determines that the first scheduled completion time coincides with the second scheduled completion time.

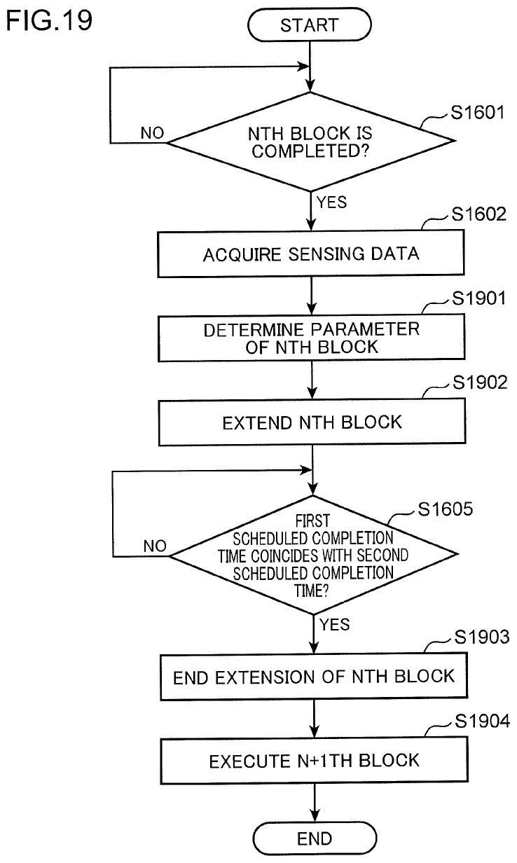

FIG. 19 is a flowchart illustrating an example of processing of the server 2E according to the sixth embodiment of the present disclosure. In the flowchart of FIG. 19, the same processing as those in FIG. 16 are denoted by the same reference numerals, and description thereof is omitted.

In step S1901 subsequent to step S1602, the extension unit 224E determines a parameter of the Nth block during extension based on the parameter table T7 illustrated in FIG. 7 and the sensing data acquired in step S1602. Details of determination of this parameter are the same as those in the first embodiment, and thus description thereof is omitted.

In step S1902, the extension unit 224E updates the parameter of the Nth block with the parameter determined in step S1602, and extends the Nth block with the parameter updated.

When it is determined that the first scheduled completion time coincides with the second scheduled completion time (YES in step S1605) in step S1605, the extension unit 224E ends the extension of the Nth block (step S1903). In contrast, when it is determined that the first scheduled completion time does not coincide with the second scheduled completion time (NO in step S1605), the processing waits in step S1605.

In step S1904, the extension unit 224E executes the N+1 th block.

As described above, the sixth embodiment causes the Nth block to be extended when the first scheduled completion time does not coincide with the second scheduled completion time. Thus, even when processes up to the Mth process are delayed, the state of the processing object at completion of the Nth block is maintained, and thus enabling completion time of the N+1th block to coincide with completion time of the Mth process while suppressing deterioration in quality of the processing object.

The present disclosure can adopt the following modifications.
(1) All or some of the various blocks included in the servers 2 to 2E in the first to sixth embodiments may be included in the terminal 3.
(2) Although the application in each of the first to fourth embodiments executes the operation mode of cooking cooked rice of the rice cooker, the present disclosure is not limited to this. The application may execute another operation mode of the rice cooker, or may execute a certain operation mode of the apparatus 4 other than the rice cooker. Although the sequence in each of the first to fourth embodiments instructs a person to prepare the cooked rice, the present disclosure is not limited to this. The sequence may instruct the person to prepare a dish other than the cooked rice.
(3) Although the application in each of the fifth and sixth embodiments executes the operation mode of the standard course of the washing machine, the present disclosure is not limited to this. The application may execute an operation mode of another course of the washing machine, or may execute an operation mode of a certain course of the apparatus 4 other than the washing machine. Although the sequence in each of the fifth and sixth embodiments includes cooking, taking a meal, and tidying up, this is an example. The sequence may include another process.
(4) The sequence in each of the first to fourth embodiments may further include a process of operating the apparatus 4. This case causes the process to actually serve as a block.

The present disclosure is useful in the field of controlling an apparatus with an application including a block.

1. An information processing method that is executed by a computer, the method comprising:
starting an application including multiple blocks each having a parameter for controlling an apparatus including at least one of an actuator and a heater, and a sequence including one or more processes involving at least a motion of a person, the sequence cooperating with an N+1th block (N is an integer of 1 or more) of the application after completion of an Mth process (M is an integer of 1 or more);
generating a state maintaining block having a parameter for maintaining a state of a processing object of the apparatus at completion of an Nth block; and
executing the generated state maintaining block when completion of the Nth block is detected.

2. The information processing method according to claim 1, further comprising ending the state maintaining block and executing the N+1th block when completion of the Mth process is detected during execution of the state maintaining block.

3. The information processing method according to claim 1, wherein
the state maintaining block includes multiple parameters with different priorities, and
the multiple parameters are different in accordance with a type of the Nth block.

4. The information processing method according to claim 3, further comprising acquiring power consumption of the apparatus,
wherein the executing the state maintaining block includes determining the parameters to be executed by the apparatus based on the acquired power consumption and the corresponding priorities.

5. The information processing method according to claim 1, wherein the sequence further includes a process of operating an apparatus.

6. The information processing method according to claim 1, wherein the generating the state maintaining block includes determining generation of the state maintaining block when delays of processes up to an M−1th process are detected.

7. The information processing method according to claim 1, wherein the generating the state maintaining block includes acquiring, from a sensor of the apparatus, sensing data indicating a state of the processing object of the apparatus at completion of the Nth block, and determining a value of the parameter of the state maintaining block based on the sensing data.

8. An information processing device comprising:
a starter configured to start an application including multiple blocks each including a parameter for controlling an apparatus including at least one of an actuator and a heater, and a sequence including one or more processes involving at least a motion of a person, the sequence cooperating with an N+1th block (N is an integer of 1 or more) of the application after completion of an Mth process (M is an integer of 1 or more);
a generator configured to generate a state maintaining block having a parameter for maintaining a state of a processing object of the apparatus at completion of an Nth block; and
an execution unit configured to execute the state maintaining block when completion of the Nth block is detected.

9. An information processing method that is executed by a computer, the method comprising:
starting an application including multiple blocks each having a parameter for controlling an apparatus including at least one of an actuator and a heater, and a sequence including one or more processes involving at least a motion of a person, the sequence cooperating with an N+1th block (N is an integer of 1 or more) of the application after completion of an Mth process (M is an integer of 1 or more); and
extending an Nth block until the Mth process is completed.

10. An information processing device comprising:
a starter configured to start an application including multiple blocks each including a parameter for controlling an apparatus including at least one of an actuator and a heater, and a sequence including one or more processes involving at least a motion of a person, the sequence cooperating with an N+1th block (N is an integer of 1 or more) of the application after completion of an Mth process (M is an integer of 1 or more); and
an extension unit configured to extend an Nth block until the Mth process is completed.

11. An information processing method that is executed by a computer, the method comprising:
starting an application including multiple blocks each having a parameter for controlling an apparatus including at least one of an actuator and a heater, and a sequence including one or more processes involving at least a motion of a person;
repeatedly calculating a first scheduled completion time of an N+1th block (N is an integer of 1 or more) of the application and a second scheduled completion time of an Mth process (M is an integer of 1 or more) of the sequence;
generating a state maintaining block including a parameter for maintaining a state of a processing object of the apparatus at completion of an Nth block; determining whether the first scheduled completion time coincides with the second scheduled completion time; and
executing the state maintaining block until determination is made that the first scheduled completion time coincides with the second scheduled completion time.

12. The information processing method according to claim 11, wherein
the first scheduled completion time is calculated by adding a total time to a current time, the total time being acquired by totaling a remaining time with respect to a reference time predetermined for a block currently being executed and a reference time predetermined for each of blocks from a block to be executed subsequently, to the N+1th block, and
the second scheduled completion time is calculated by adding a total time to a current time, the total time being acquired by totaling a remaining time with respect to a reference time predetermined for a process currently being executed and a reference time predetermined for each of processes from a process to be executed subsequently, to the Mth process.

13. An information processing device comprising:
a starter configured to start an application including multiple blocks each having a parameter for controlling an apparatus including at least one of an actuator and a heater, and a sequence including one or more processes involving at least a motion of a person;
a calculator configured to repeatedly calculate a first scheduled completion time of an N+1th block (N is an integer of 1 or more) of the application and a second scheduled completion time of an Mth process (M is an integer of 1 or more) of the sequence;
a generator configured to generate a state maintaining block including a parameter for maintaining a state of a processing object of the apparatus at completion of an Nth block;
a determination unit configured to determine whether the first scheduled completion time coincides with the second scheduled completion time; and
an execution unit configured to execute the state maintaining block until determination is made by the determination unit that the first scheduled completion time coincides with the second scheduled completion time.

14. An information processing method that is executed by a computer, the method comprising:
starting an application including multiple blocks each having a parameter for controlling an apparatus including at least one of an actuator and a heater, and a sequence including one or more processes involving at least a motion of a person;
repeatedly calculating a first scheduled completion time of an N+1th block (N is an integer of 1 or more) of the application and a second scheduled completion time of an Mth process (M is an integer of 1 or more) of the sequence;
determining whether the first scheduled completion time coincides with the second scheduled completion time; and
extending an Nth block until determination is made that the first scheduled completion time coincides with the second scheduled completion time.

15. An information processing device comprising:
a starter configured to start an application including multiple blocks each having a parameter for controlling an apparatus including at least one of an actuator and a heater, and a sequence including one or more processes involving at least a motion of a person;
a calculator configured to repeatedly calculate a first scheduled completion time of an N+1th block (N is an integer of 1 or more) of the application and a second scheduled completion time of an Mth process (M is an integer of 1 or more) of the sequence;
a determination unit configured to determine whether the first scheduled completion time coincides with the second scheduled completion time; and
an extension unit configured to extend an Nth block until the determination unit determines that the first scheduled completion time coincides with the second scheduled completion time.
